(19) United States
(12) Patent Application Publication
(10) Pub. No.: US 2026/0254068 A1
(43) Pub. Date: Aug. 27, 2026

(54) SECONDARY BATTERY

(71) Applicant: SK On Co., Ltd., Seoul (KR)

(72) Inventor: Seung Min LEE, Daejeon (KR)

(21) Appl. No.: 19/537,491

(22) Filed: Feb. 12, 2026

(30) Foreign Application Priority Data
Feb. 21, 2025 (KR) 10-2025-0023076

(51) Int. Cl. H01M 50/583

(52) U.S. Cl. CPC H01M 50/583; H01M 2200/103

(57) ABSTRACT

Proposed is a secondary battery, including an electrode assembly in which a positive electrode and a negative electrode are assembled together, a fuse part electrically connected to the electrode assembly, and an electrode lead electrically connected to the fuse part, in which the fuse part interrupts an electrical connection at a temperature equal to or higher than a predetermined threshold temperature and re-establishes the electrical connection at a temperature below the predetermined threshold temperature.

### CROSS REFERENCE TO RELATED APPLICATION

The present application claims priority to Korean Patent Application No. 10-2025-0023076, filed February 21, 2025, the entire contents of which is incorporated herein for all purposes by this reference.

### BACKGROUND OF THE INVENTION

### Field of the Invention

The present disclosure relates to a secondary battery.

### Description of the Related Art

In general, secondary batteries refer to batteries capable of repeated use through cycles of a discharge process in which chemical energy is converted into electrical energy and a charge process in which electrical energy is converted into chemical energy.

Examples of secondary batteries may include nickel-cadmium (Ni-Cd) batteries, nickel-metal hydride (Ni-MH) batteries, lithium-metal batteries, lithium-ion (Li-ion) batteries, and lithium-ion polymer batteries.

Of these, lithium secondary batteries exhibit several advantageous characteristics. They typically have a long cycle life exceeding about 500 cycles and offer a short charging time of approximately 1 to 2 hours. Additionally, the lithium secondary batteries are approximately 30% to 40% lighter than Ni-MH batteries, enabling significant weight reduction in products. They also provide the highest cell voltage per unit cell and superior energy density among the existing secondary batteries, rendering them particularly suitable for application in mobile devices.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent Application Publication No. 10-2003-0033210

### SUMMARY OF THE INVENTION

According to one aspect of the present disclosure, there is provided a secondary battery with enhanced stability against high current or short-circuit conditions.

According to another aspect of the present disclosure, there is provided a secondary battery applicable to various green-technology fields, including electric vehicles, battery charging stations, and battery-based solar and wind power generation systems.

A secondary battery according one embodiment of the present disclosure may include: an electrode assembly in which a positive electrode and a negative electrode are assembled together; a fuse part configured to be electrically connected to the electrode assembly; and an electrode lead configured to be electrically connected to the fuse part, in which the fuse part may interrupt an electrical connection at a temperature equal to or higher than a predetermined threshold temperature and re-establish the electrical connection at a temperature below the predetermined threshold temperature.

The fuse part may be transformed into a high-resistance body incapable of electrical conduction at the temperature equal to or higher than the predetermined threshold temperature, and be transformed into a low-resistance body capable of electrical conduction at the temperature below the predetermined threshold temperature.

The fuse part may include a polymer resin and a conductive carbon black material.

The fuse part may be connected to the electrode assembly and the electrode lead at the temperature below the predetermined threshold temperature, and release a connection with either the electrode assembly or the electrode lead at the temperature equal to or higher than the predetermined threshold temperature.

The fuse part may include a bimetal material.

The fuse part may include a plurality of fuse parts that are connected in parallel between the electrode assembly and the electrode lead.

The fuse part may include: a first coupling portion coupled to the electrode assembly; a second coupling portion coupled to the electrode lead; and a fuse provided between the first coupling portion and the second coupling portion, and configured to interrupt an electrical connection at the temperature equal to or higher than the predetermined threshold temperature and re-establish the electrical connection at the temperature below the predetermined threshold temperature.

The fuse may include a plurality of fuses that are arranged in parallel between the first coupling portion and the second coupling portion.

The secondary battery may further include: a support portion made of an insulating material, and configured to connect the first coupling portion and the second coupling portion to each other while maintaining a spacing therebetween.

The features and advantages of the present disclosure will be more clearly understood from the following detailed description when taken in conjunction with the accompanying drawings.

The terms and words used in the specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe the best method he or she knows for carrying out the present disclosure.

According to one embodiment of the present disclosure, the secondary battery can immediately open a circuit and interrupt current flow upon instant application of a high current.

According to one embodiment of the present disclosure, the secondary battery can ensure safety under abnormal current conditions.

According to one embodiment of the present disclosure, the secondary battery can prevent direct contact between an electrode lead and an electrode assembly.

According to one embodiment of the present disclosure, the secondary battery can restore its original function after returning to normal conditions following an overcurrent event.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a front view illustrating the interior of a secondary battery according to a first embodiment of the present disclosure;

FIG. 2 is an enlarged view of region "A" in FIG. 1, schematically illustrating a fuse part;

FIG. 3 is an enlarged plan view of region "B" in FIG. 2;

FIG. 4 is a use-state view illustrating an operating state of a fuse part of a secondary battery according to a second embodiment of the present disclosure under normal temperature conditions;

FIG. 5 is a use-state view illustrating an operating state of the fuse part of the secondary battery according to the second embodiment of the present disclosure under high-temperature conditions;

FIG. 6 is an enlarged plan view illustrating the fuse part of the secondary battery according to the second embodiment of the present disclosure;

FIG. 7 is an enlarged plan view illustrating a fuse part of a secondary battery according to a third embodiment of the present disclosure; and

FIG. 8 is an enlarged plan view illustrating a fuse part of a secondary battery according to a fourth embodiment of the present disclosure.

### DETAILED DESCRIPTION OF THE INVENTION

The terminology used to describe an embodiment of the present disclosure is not intended to limit the present disclosure. As used herein, the singular forms are intended to include the plural forms as well, unless the context clearly indicates otherwise.

As for reference numerals associated with parts in the drawings, the same or similar reference numerals will refer to the same or similar elements throughout different drawings.

Note that the drawings may be schematic or exaggerated to illustrate implementations. The terms “have”, “may have”, “include”, and “may include” as used herein indicate the presence of corresponding features (for example, elements such as numerical values, functions, operations, or parts), and do not preclude the presence of additional features.

Although the terms “one”, “other”, “another”, “first”, “second”, etc. may be used only to distinguish one element from another element, these elements should not be limited by these terms.

Hereinbelow, an exemplary embodiment of the disclosure will be described in detail with reference to accompanying drawings.

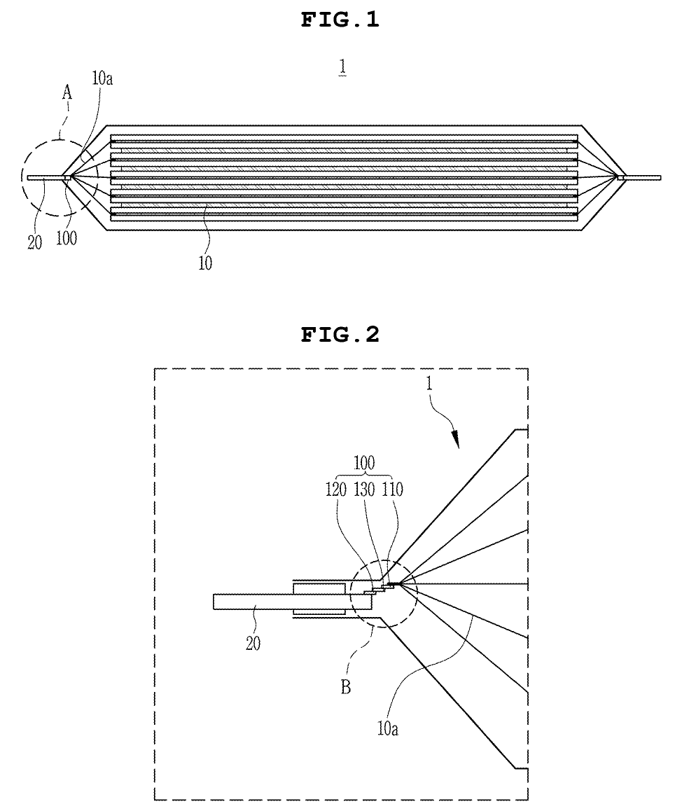

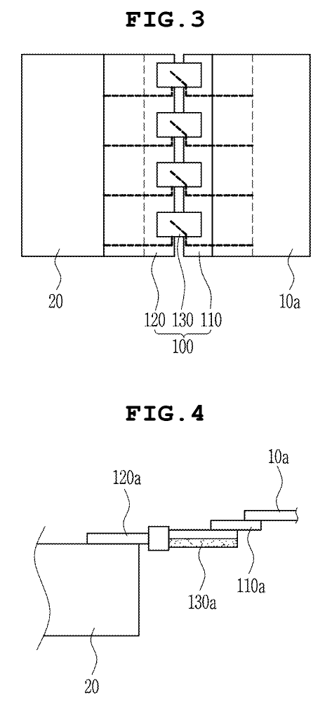

FIG. 1 is a front view illustrating the interior of a secondary battery according to a first embodiment of the present disclosure, FIG. 2 is an enlarged view of region "A" in FIG. 1, schematically illustrating a fuse part, and FIG. 3 is an enlarged plan view of region "B" in FIG. 2.

Referring to FIGS. 1 to 3, a secondary battery 1 according to a first embodiment of the present disclosure includes an electrode assembly 10 in which a positive electrode and a negative electrode are assembled together, a fuse part 100 electrically connected to the electrode assembly 10, and an electrode lead 20 electrically connected to the fuse part 100. The fuse part 100 may interrupt an electrical connection at a temperature equal to or higher than a predetermined threshold temperature and re-establish the electrical connection at a temperature below the predetermined threshold temperature.

In the present disclosure, the secondary battery 1 may be any one of pouch-type, prismatic-type, and cylindrical type cells.

The electrode assembly 10 may be prepared by repeatedly arranging a positive electrode, a negative electrode, and a separator.

The electrode assembly 10 may be implemented in the form of a winding type, a stacking type, a z-folding type, or a stack folding type.

The electrode assembly 10 may be provided with an uncoated portion bundle 10a at each of opposite ends thereof. The uncoated portion bundle 10a may include a plurality of uncoated portions welded together.

Alternatively, the electrode assembly 10 may be provided with an uncoated portion bundle 10a only at one end thereof in one direction.

The electrode lead 20 may be electrically connected to the electrode assembly 10 through the fuse part 100.

The electrode lead 20 may be a conductor such as copper, aluminum, or iron.

Additionally, the electrode lead 20 may extend to the outside of the secondary battery 1 so as to be electrically connected to an external electrical device.

The fuse part 100 may open a circuit under an overcurrent condition and may close the circuit again under normal operating conditions.

That is, the fuse part 100 may establish an electrical connection between the electrode assembly 10 and the electrode lead 20 under a normal condition, interrupt the electrical connection between the electrode assembly 10 and the electrode lead 20 under an overcurrent condition, and then re-establish the electrical connection when the normal condition is restored.

The fuse part 100 may be provided between the electrode assembly 10 and the electrode lead 20.

The fuse part 100 may be disposed between the electrode assembly 10 and the electrode lead 20. The fuse part 100 may be provided in either singular or plural.

When a plurality of fuse parts 100 are provided, the fuse parts 100 may be connected in parallel between the electrode assembly 10 and the electrode lead 20.

The parallel arrangement of the plurality of fuse parts 100 between the electrode assembly 10 and the electrode lead 20 allows that, when the fuse parts 100 attempt to re-establish an electrical connection after interrupting it, the functional performance of the fuse parts 100 is preserved. Specifically, even when one of the plurality of fuse parts 100 becomes damaged or malfunctioned, the remaining fuse parts 100 may continue to operate normally and re-establish the electrical connection.

The fuse part 100 may be electrically connected to the uncoated portion bundle 10a of the electrode assembly 10.

The fuse part 100 may have an end welded to the uncoated portion bundle 10a by ultrasonic welding, laser welding, or the like. However, the present disclosure is not limited thereto, and various other coupling methods capable of securing the fuse part 100 to the uncoated portion bundle 10a may also be employed.

The fuse part 100 may include a first coupling portion 110, a second coupling portion 120, and a fuse 130.

The first coupling portion 110 according to the first embodiment of the present disclosure may be coupled to the electrode assembly 10.

The first coupling portion 110 may be a conductor such as copper, iron, or aluminum.

The first coupling portion 110 may extend toward the electrode assembly 10. The first coupling portion 110 may be configured such that the uncoated portion bundle 10a of the electrode assembly 10 is welded to one side of one end thereof.

The second coupling portion 120 may be coupled to the electrode lead 20.

The second coupling portion 120 may be a conductor such as copper, iron, or aluminum.

The second coupling portion 120 may extend toward the electrode lead 20. The second coupling portion 120 may be configured such that the electrode lead 20 is welded to one side of one end thereof.

When comparing a position at which the second coupling portion 120 and the electrode lead 20 are welded together with a position at which the first coupling portion 110 and the uncoated portion bundle 10a are welded together, the two positions may be located in opposite directions with respect to the fuse 130.

That is, in one embodiment, when the uncoated portion bundle 10a of the electrode assembly 10 is coupled to an upper side of the first coupling portion 110 with respect to the fuse 130, the electrode lead 20 may be coupled to a lower side of the second coupling portion 120.

On the contrary, when the uncoated portion bundle 10a of the electrode assembly 10 is coupled to a lower side of the first coupling portion 110 with respect to the fuse 130, the electrode lead 20 may be coupled to an upper side of the second coupling portion 120.

The fuse 130 may be provided between the first coupling portion 110 and the second coupling portion 120. The fuse 130 may maintain an electrical connection under normal operating conditions, interrupt the electrical connection at temperature equal to or higher than a predetermined threshold temperature, and then re-establish the electrical connection at a temperature below the predetermined threshold temperature.

The fuse 130 may be provided in either singular or plural.

When a plurality of fuses 130 are provided, the fuses 130 may be arranged in parallel between the first coupling portion 110 and the second coupling portion 120.

The fuse 130 may heat up due to Joule heating when an overcurrent occurs. When the temperature of the fuse 130 is equal to or higher than a predetermined threshold temperature, a polymer resin constituting the fuse 130 may undergo melting, transforming the fuse 130 into a high-resistance body incapable of electrical conduction, thereby cutting off the flow of current.

When the temperature of the fuse 130 decreases to below the predetermined threshold temperature, the fuse 130 may return to a low-resistance body capable of electrical conduction, thereby restoring its resistance value and allowing current to flow again.

In the present disclosure, the predetermined threshold temperature may be 80°C at which the lithium secondary battery may undergo rapid degradation due to side reactions.

The fuse 130 may include a polymer resin and a conductive carbon black material.

The polymer resin may include at least one selected from the group consisting of polypropylene, polyethylene, polystyrene, polyethylene terephthalate, and polycarbonate.

That is, the fuse 130 may be made of a polymer resin and conductive particles (carbon black) dispersed therein.

The polymer resin may firmly bind the conductive particles within its crystalline structure to form chain-shaped conductive pathways.

The fuse 130 may remain in a low-resistance state at a temperature below the predetermined threshold temperature, thereby allowing current to flow.

The polymer resin of the fuse 130 may melt at the temperature equal to or higher than the predetermined threshold temperature.

Due to the volumetric expansion associated with the melting of the polymer resin, the fuse 130 may transition into a high-resistance state, thereby cutting off the flow of current.

When the fuse 130 cools down to a temperature below the predetermined threshold temperature, the polymer resin may recrystallize and contract back to its original volume, allowing the conductive particles to reform the conductive pathways. The fuse 130 may then return to a low-resistance state, allowing current to flow again.

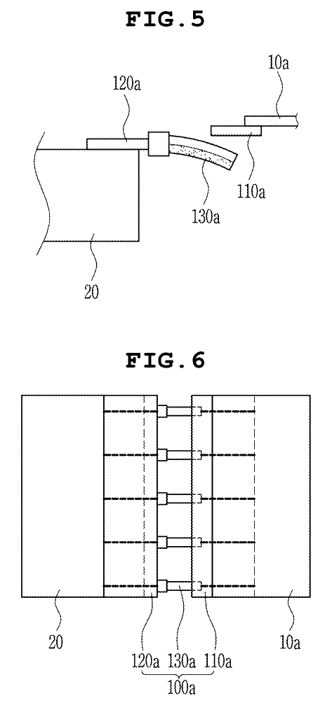

FIG. 4 is a use-state view illustrating an operating state of a fuse part of a secondary battery according to a second embodiment of the present disclosure under normal temperature conditions, FIG. 5 is a use-state view illustrating an operating state of the fuse part of the secondary battery according to the second embodiment of the present disclosure under high-temperature conditions, and FIG. 6 is an enlarged plan view illustrating the fuse part of the secondary battery according to the second embodiment of the present disclosure.

Referring to FIGS. 4 to 6, a first coupling portion 110a of a fuse part 100a according to the second embodiment of the present disclosure may be coupled to an electrode assembly 10.

The first coupling portion 110a may be a conductor such as copper, iron, or aluminum.

The first coupling portion 110a may extend toward the electrode assembly 10. The first coupling portion 110a may be configured such that an uncoated portion bundle 10a of the electrode assembly 10 is welded to one side of one end thereof.

The second coupling portion 120a may be coupled to an electrode lead 20.

The second coupling portion 120a may be a conductor such as copper, iron, or aluminum.

The second coupling portion 120a may extend toward the electrode lead 20. The second coupling portion 120a may be configured such that the electrode lead 20 is welded to one side of one end thereof.

When comparing a position at which the second coupling portion 120a and the electrode lead 20 are welded together with a position at which the first coupling portion 110a and the uncoated portion bundle 10a are welded together, the two positions may be located in opposite directions with respect to a fuse 130a.

That is, in one embodiment, when the uncoated portion bundle 10a of the electrode assembly 10 is coupled to an upper side of the first coupling portion 110a with respect to the fuse 130a, the electrode lead 20 may be coupled to a lower side of the second coupling portion 120a.

On the contrary, when the uncoated portion bundle 10a of the electrode assembly 10 is coupled to a lower side of the first coupling portion 110a with respect to the fuse 130a, the electrode lead 20 may be coupled to an upper side of the second coupling portion 120a.

The fuse 130a may be connected to the electrode assembly 10 and the electrode lead 20 through the first coupling portion 110a and the second coupling portion 120a at a temperature below a predetermined threshold temperature.

The fuse 130a may release a connection with either the electrode assembly 10 or the electrode lead 20 at a temperature equal to or higher than the predetermined threshold temperature.

The fuse 130a may be provided between the first coupling portion 110a and the second coupling portion 120a.

The fuse 130a may be provided in either singular or plural.

When a plurality of fuses 130a are provided, the fuses 130a may be arranged in parallel between the first coupling portion 110a and the second coupling portion 120a.

The fuse 130a according to the second embodiment of the present disclosure may be a conductor, and may include a bimetal material formed by bringing into contact two metals having different coefficients of thermal expansion.

In one embodiment, the bimetal may be made of copper and iron. However, the present disclosure is not limited thereto, and any conductive metals having different coefficients of thermal expansion may also be employed.

Referring to FIG. 4, under normal operating conditions, e.g., when the temperature of the fuse 130a is below the predetermined threshold temperature, the fuse 130a may establish an electrical connection between the electrode assembly 10 and the electrode lead 20, allowing current to flow normally.

Referring to FIG. 5, when the temperature is equal to or higher than the predetermined threshold temperature, the bimetal may bend toward one side, thereby interrupting the electrical connection between the electrode assembly 10 and the electrode lead 20 and cutting off the flow of current.

When the temperature decreases below the predetermined threshold temperature, the bimetal may straighten, thereby re-establishing the electrical connection between the electrode assembly 10 and the electrode lead 20 and allowing normal current flow to resume.

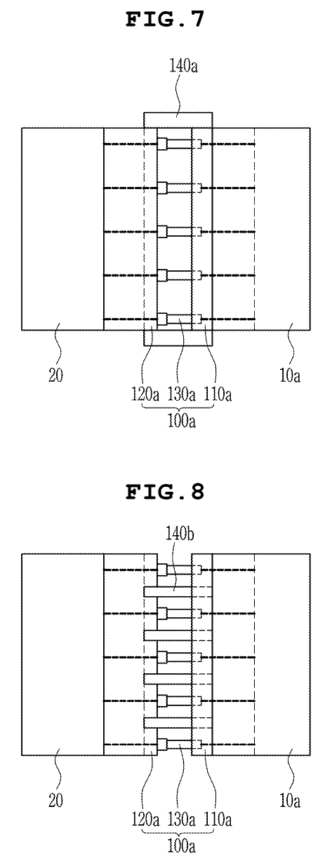

FIG. 7 is an enlarged plan view illustrating a fuse part of a secondary battery according to a third embodiment of the present disclosure.

Referring to FIG. 7, a secondary battery according to the third embodiment of the present disclosure may include a support portion 140a in addition to the configuration identical to that of the aforementioned second embodiment.

Therefore, a duplicate description of the same configuration as the second embodiment will be omitted.

The support portion 140a according to the third embodiment of the present disclosure may connect a first coupling portion 110a and a second coupling portion 120a to each other while maintaining a spacing therebetween.

That is, the support portion 140a may complement the fixing force between the first coupling portion 110a and the second coupling portion 120a.

The support portion 140a may be provided in either singular or plural.

In one embodiment, the support portion 140a may connect the outer peripheral edges of the first coupling portion 110a and the second coupling portion 120a to each other.

The support portion 140a may be an insulator such as glass or plastic.

FIG. 8 is an enlarged plan view illustrating a fuse part of a secondary battery according to a fourth embodiment of the present disclosure.

Referring to FIG. 8, a support portion 140b of the fourth embodiment may be a modification of the support portion 140a of the third embodiment illustrated in FIG. 7.

Therefore, a duplicate description of the same configuration as the third embodiment will be omitted, and the same reference numerals are used for constituent elements common to the third embodiment.

The support portion 140b according to the fourth embodiment of the present disclosure may connect a first coupling portion 110a and a second coupling portion 120a to each other while maintaining a spacing therebetween.

The support portion 140b may have a first end extending toward the first coupling portion 110a and may be coupled to the first coupling portion 110a along the length thereof.

The support portion 140b may have a second end opposite to the first end and extending toward the second coupling portion 120a and may be coupled to the second coupling portion 120a along the length thereof.

With this configuration, the support portion 140b may complement the fixing force between the first coupling portion 110a and the second coupling portion 120a while reinforcing the strength (durability) of the first coupling portion 110a and the second coupling portion 120a.

Hereinabove, the present disclosure has been described in detail with reference to a specific embodiment. The embodiment is intended to illustrate the present disclosure in detail, and the present disclosure is not limited thereto. It will be apparent to those skilled in the art that modifications thereto or improvements thereof are possible within the technical spirit of the present disclosure. All simple modifications and alterations of the present disclosure fall within the scope of the present disclosure, and the specific protection scope of the present disclosure will be clearly defined by the appended claims.

What is claimed is:

1. A secondary battery, comprising:
an electrode assembly in which a positive electrode and a negative electrode are assembled together;
a fuse part configured to be electrically connected to the electrode assembly; and
an electrode lead configured to be electrically connected to the fuse part,
wherein the fuse part interrupts an electrical connection at a temperature equal to or higher than a predetermined threshold temperature and re-establish the electrical connection at a temperature below the predetermined threshold temperature.

2. The secondary battery of claim 1, wherein the fuse part is transformed into a high-resistance body incapable of electrical conduction at the temperature equal to or higher than the predetermined threshold temperature, and is transformed into a low-resistance body capable of electrical conduction at the temperature below the predetermined threshold temperature.

3. The secondary battery of claim 2, wherein the fuse part comprises a polymer resin and a conductive carbon black material.

4. The secondary battery of claim 1, wherein the fuse part is connected to the electrode assembly and the electrode lead at the temperature below the predetermined threshold temperature, and releases a connection with either the electrode assembly or the electrode lead at the temperature equal to or higher than the predetermined threshold temperature.

5. The secondary battery of claim 4, wherein the fuse part comprises a bimetal material.

6. The secondary battery of claim 1, wherein the fuse part comprises a plurality of fuse parts that are connected in parallel between the electrode assembly and the electrode lead.

7. The secondary battery of claim 1, wherein the fuse part comprises:
a first coupling portion coupled to the electrode assembly;
a second coupling portion coupled to the electrode lead; and
a fuse provided between the first coupling portion and the second coupling portion, and configured to interrupt an electrical connection at the temperature equal to or higher than the predetermined threshold temperature and re-establish the electrical connection at the temperature below the predetermined threshold temperature.

8. The secondary battery of claim 7, wherein the fuse comprises a plurality of fuses that are arranged in parallel between the first coupling portion and the second coupling portion.

9. The secondary battery of claim 7, further comprising:
a support portion made of an insulating material, and configured to connect the first coupling portion and the second coupling portion to each other while maintaining a spacing therebetween.
